(19) United States
(12) Patent Application Publication
(10) Pub. No.: US 2015/0127546 A1
(43) Pub. Date: May 7, 2015

(54) METHODS FOR PROVIDING INTERNET SERVICES THROUGH A TOLL FREE CONNECTION TO A USER AND DEVICES THEREOF

(71) Applicant: INFOSYS LIMITED, Bangalore (IN)

(72) Inventors: Ashutosh Saxena, Hyderabad (IN); Nitin Singh Chauhan, Hyderabad (IN)

(21) Appl. No.: 14/492,166

(22) Filed: Sep. 22, 2014

(30) Foreign Application Priority Data
Sep. 20, 2013 (IN) 4235/CHE/2013

(51) Int. Cl. H04L 29/06; G06Q 20/38

(52) U.S. Cl. CPC H04L 63/08; G06Q 20/382
USPC 705/65; 726/9

(57) ABSTRACT

Techniques for providing internet services to a user through a toll free connection are provided. The techniques include receiving, from an Internet Access Point (IAP), a request for the internet services through the toll free connection provided by a Cloud Service Provider (CSP), wherein the CSP is selected by the user from a plurality of CSPs. Access credentials are received from IAP and are forwarded to the selected CSP. A token is received from the CSP if the user is authenticated by the CSP based on the access credentials. The token is sent to the IAP wherein the token is used by the user to access the Internet services through the toll free connection.

This application claims the benefit of Indian Patent Application Filing No. 4235/CHE/2013, filed Sep. 20, 2013, which is hereby incorporated by reference in its entirety.

### FIELD

This technology relates to the field of Internet access and more particularly to methods for providing internet services through a toll free connection to a user and devices thereof.

### BACKGROUND

Internet has replaced many conventional ways to perform some activities like information searching, bill payment, performing banking transactions etc. Recently, internet enabled service i.e. cloud services has increasingly used not only by the enterprises but common man is also getting benefited by use of these cloud services. To access any cloud service, user needs to access Internet. Increase dependency over the internet mandate large number of people to access Internet. However cost and convenience issues with respect to Internet access are obstructions in swift proliferation of Internet Services.

Generally, for accessing Internet services, users are required to pay for such services to an Internet Service Provider (hereinafter ISP). Usually, the ISP charges the user based on their usage of Internet Services. Toll-free telephone system is very common practice in many business scenarios where call charges are charged from receiver instead of dialer. Similar methods have been adopted for accessing Internet services wherein access to certain websites is free for the user of that website. Any charges associated to such website access are paid by website providers to the Internet service provider. However such website provider prevents the user from communicating with any other website/internet service other than those authorized by the website provider. This limits free Internet access to certain websites, controlled by that website provider. Moreover, user needs to provide login information for that website, to access. User accessing multiple websites offering toll-free services needs to provide separate authentication against each website separately.

Though, techniques might exist to cater the problem of accessing certain Internet services from toll free connection, however, the existing techniques does not leverages cloud environment for providing toll-free access to all available Internet services including cloud services without levying any charges to the user.

Therefore, there is a general need to provide internet services through a toll free connection to a user leveraging cloud environment. Several aspects of the present disclosure discloses a method and a system for providing internet services through a toll free connection to a user as described in details in below sections.

### SUMMARY

Accordingly, an example of this technology is directed to a device, non-transitory computer readable medium and method for providing internet services to a user through a toll free connection are provided. The techniques include receiving, from an Internet Access Point (IAP), a request for the internet services through the toll free connection provided by a Cloud Service Provider (CSP), wherein the CSP is selected by the user from a plurality of CSPs. Access credentials are received from IAP to access the selected CSP. The access credentials are forwarded to the selected CSP. A token is received from the CSP if the user is authenticated by the CSP based on the access credentials. The token is sent to the IAP wherein the token is used by the user to access the Internet services through the toll free connection.

Another example of this technology is directed to a device, non-transitory computer readable medium and method for generating a token to be used for providing internet services to a user by a Cloud Service Provider (CSP) through a toll free connection are provided. The method comprising receiving a request to access the Internet services through the toll free connection. Access credentials are provided by a user from an Internet Access Point (IAP). The user is authenticated by matching the received access credentials with corresponding access credentials stored at the CSP. A token is generated based on the access credentials and the token is send to the user wherein the user uses the token to access the Internet services through the toll free connection.

Further, in another example, the token and usage attributes are received from an Internet Service Provider (ISP) and payment for the user usage of the Internet services are settled based on the received token and the usage attributes.

### BRIEF DESCRIPTION OF THE DRAWINGS

FIG. 1 is a flow chart of an example of a method for providing internet services through a toll free connection to a user.

FIG. 2 is a flow chart of an example of a method for generating a token to be used for providing internet services to a user by a Cloud Service Provider (CSP) through a toll free connection.

FIG. 3 is a diagram of an example of system that provides internet services through a toll free connection to a user.

FIG. 4 is a block diagram of an example of a token management engine.

FIG. 5A is a timing diagram of an example of a method for providing a toll free connection to access internet services where a token is received by IAP

FIG. 5B is a timing diagram of an example of a method providing a toll free connection to access internet services where a token is received by ISP

FIG. 6 is an example of a computing device useful for performing processes disclosed herein.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings. While the invention described herein is provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof.

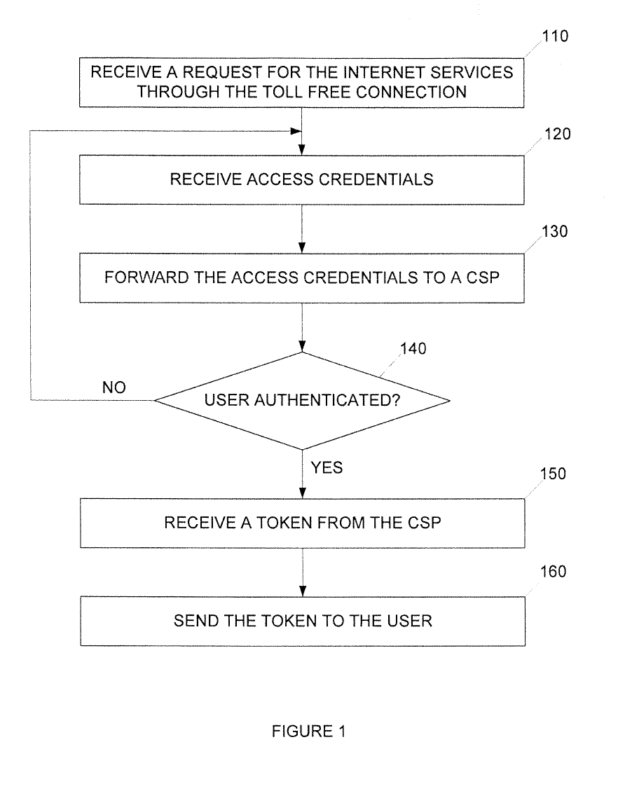

FIG. 1 illustrates a process flow for providing internet services through a toll free connection to a user. As used herein, a “user” may be an individual or a group of individuals that desires to accesses Internet services. Conventionally, for accessing internet services, Internet Service Provider (hereinafter, it is abbreviated as ISP) charges the users for their usage of the internet services. “ISP” or “Internet Service Provider” refers to a company that provides users' access to the Internet and other cloud related services. An ISP maintains the equipment and the communication link required to have an access point to the Internet. Unlike conventional method where ISP charges the user for the internet usage, the disclosure discloses a method and a system where the user does not pay any charges for their internet usage.

At step 110, a request for Internet services through a toll free connection, is received by CAPD through ISP, from a user using an Internet Access Point (hereinafter, it is abbreviated an IAP). Typically, Internet Services refer to services that can be provided via the internet, such as CoD (Content's on Demand) services, information services including weather forecasts, search services, and so on, communication services including TV mailing services, TV SMS (Short Message Services), and cloud services such as software as a service, platform as a service and so on. The toll free connection for accessing Internet service may be provided by different Cloud Service Provider (hereinafter, it is abbreviated a CSP). The user can select one CSP from the plurality of CSP (who are providing toll free connection) for accessing the Internet services. The request for Internet service sent by the user may contain the selected CSP details such as name of the CSP. As used herein, the CSP refers to a service provider which provides cloud services which generally refers to the notion that a service is performed not locally from a user's device, but rather delivered from one or more remote devices accessible via one or more networks. Since the user's device does not need to understand the details of what happens at the one or more remote devices, the service appears to be delivered from a “cloud” from the perspective of the user's device.

At step 120, access credentials to access the selected CSP are received. The access credentials may include user parameters such as username, password and the like; an IAP identifier; an ISP identifier and service parameters such as time for which user wants to access internet services, type of service user prefer and the like. The IAP identifier refers to a unique identifier belonging to the IAP for the CSP to authenticate the IAP. The IAP identifier could be a public key certificate of IAP or could be determined based on any known technique. Similarly, the ISP identifier refers to a unique identifier identifying the ISP for the CSP to authenticate the ISP. The ISP identifier could be a public key certificate of ISP or could be determined based on any known technique.

At step 130, the access credentials are forwarded to the selected CSP. At step 140, CSP checks for the authenticity of the user based on the access credentials. If the user is a first time user, the user can register with the CSP to avail toll free connection for accessing Internet services. If the user is a subsequent user, the CSP can map his access credentials stored at CSP with the received access credentials and authenticate the user if the credentials match. If the access credentials do not match, the user may be asked to send the access credentials again. At step 150, if the access credentials match, a token generated by the CSP is received. At step 160, the token is sent to the IAP for the user to use the token to access the Internet services on a toll free connection. The token may be a unique numeric or alpha numeric random number generated.

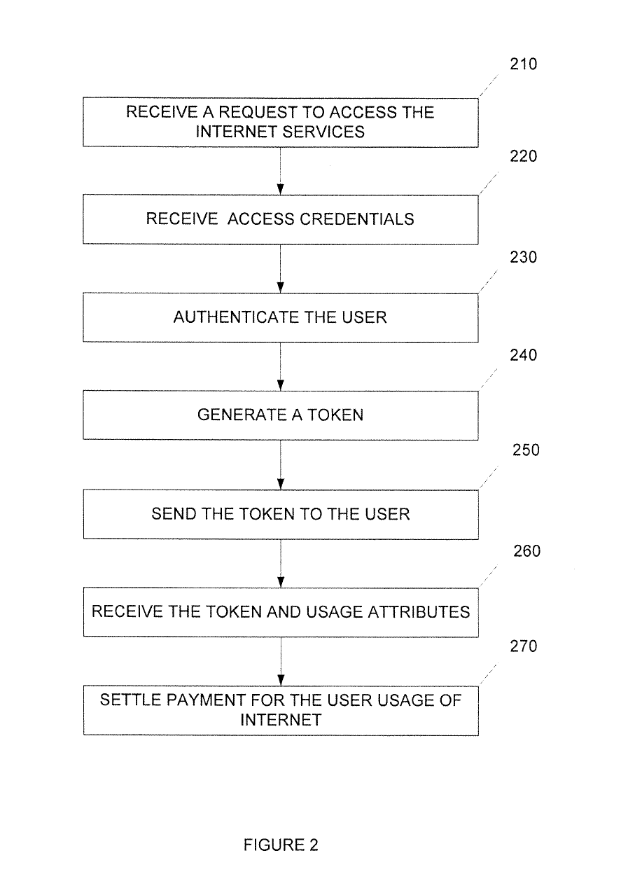

FIG. 2 illustrates a process flow for generating a token to be used for providing internet services to a user by a Cloud Service Provider (CSP) through a toll free connection. At step 210, CSP receives a request for a toll free connection to access internet services. At step 220, CSP receives the access credentials of the user. At step 230, CSP authenticates the user if the receive credentials matched with the stored user credentials. If the user is authenticated, at step 240, a token is generated corresponding to the user request. The token may be generated based on the access credentials. For example, if the user has specified a service parameter (as comprised in the access credentials) e.g. service required time of 2 hours, then the token generated may be based on the service parameter and thus, the generated token may have a time span of 2 hours for the user to access internet services. At step 250, the generated token is provided to the user. The token may comprise of information such as the time span for which the user can access Internet service through a toll free connection. For example, the time span of 1 hour means that user can avail the internet services through a toll free for one hour only, after which the user may again request for another token from the CSP.

In one embodiment, generated token may further comprise of a first timestamp. The first timestamp herein refers to the time span for which the token remains active for the user to access the Internet services through the toll free connection. For example, if the first timestamp of the generated token is 2 days, then the user can avail the service of 1 hour (the time span as specified in the token as mentioned in above example) anytime within 2 days. If the user do not avail the internet services within two days, the token may become inactive.

The user can provide the token to the ISP for accessing Internet services without the user getting charged. After the user access the internet services using the token, the ISP can send the token and the usage attributes to the CSP for settling the payment. At step 260, the token and the usage attributes are received from the ISP. The usage attributes may include but not limited to, usage time data i.e. the time span for which the user has actually accessed the internet services and usage pattern data i.e. data pertaining to the pattern of usage by the user. At step 270, payment corresponding to the user usage of the internet services is settled with ISP based on the token and the usage attributes provided by the ISP.

For the purpose of illustration, if 1 hour token is generated by a CSP which has a first timestamp of 2 days, the user can access the internet service through toll free services for 1 hour. However, if the user has accessed internet services for 15 minutes on first day and again accessed for 20 minutes on second day, then the usage time data will be 35 minutes. Hence, when the ISP will send the token and the usage time data to the CSP, the CSP will settle the payment with ISP for the usage of internet service by user for 35 minutes. As appreciated by a person skilled in the art, the payment settlement between CSP and ISP may depend on any arrangement between them and in one embodiment, ISP can charge the CSP for the total time for with the token is active e.g. in this case 1 hour irrespective of the usage by the user.

In another embodiment, generated token may further comprise of a second timestamp. The second timestamp herein specifies a time span for which the token remains active for the ISP to send the token to the CSP for settlement. For example, if the second timestamp of the generated token is 1 year from the expiry date of the token, then the ISP can settle the payment with the CSP within 1 year time period for the respective token.

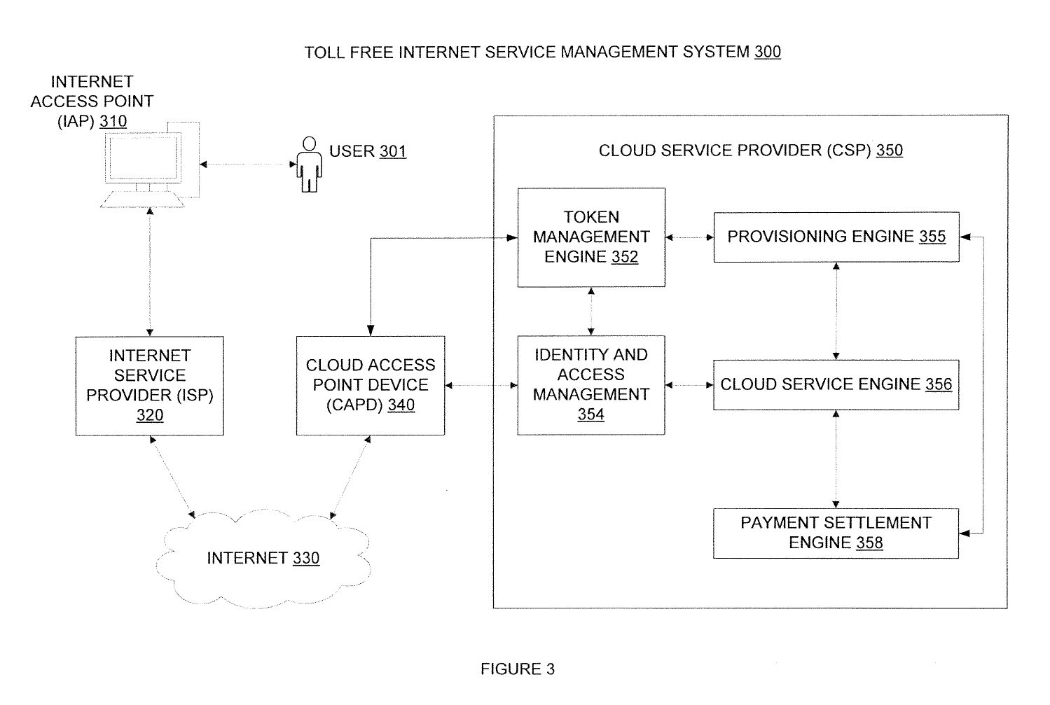

FIG. 3 illustrates an exemplary Toll free internet service management system 300 depicting the components required to provide internet services through a toll free connection to a user 301. The system 300 includes an Internet Access Point (IAP) 310, an ISP 320, at least one communication network 330, a cloud access point device 340 and a cloud service provider 350. IAP 310 could be a terminal/kiosk, hand handled device such as mobile phone etc. or computer machine from where Internet services can be accessed. IAP 310 can be a personal system of the user 301 or it can be provided by any third party such as any internet café. IAP 310 connects to Internet 330 using the service offered by ISP 320. User 301 access the internet services using IAP. IAP 310 provides user 301 with a user interface showing the option to access internet services through a toll free connection. If the user selects the option to access internet services through a toll free at IAP, the request is sent to cloud access point device 340 via ISP 320 over internet 330.

Cloud Access Point Device (hereinafter abbreviated as CAPD) 340 receives the initial request for toll-free access to Internet services from user 301 and provide IAP 310 with a user interface listing the different cloud service providers which provide the toll free connection. User 301 selects the respective cloud service provider 350 from list of cloud service providers and enters access credentials. CAPD 340 routes user log-in request to respective cloud service provider 350. Once authenticated by cloud service provider 350, CAPD 340 receives token for toll-free access to cloud services and other Internet services from CSP 350 and forward it to User 301.

CSP 350 comprises subsystems which perform the task of providing toll free connection to user 301. CSP comprises token management engine 352, Identity and access management 354, provisioning engine 355, cloud service engine 356 and payment settlement engine 358. Identity and access management 354, authenticate user and provide access to cloud service offered by cloud service provider. Identity and access management 354 identifies valid user of cloud service, so that toll-free Internet or cloud services access credits can be provided to authenticated user.

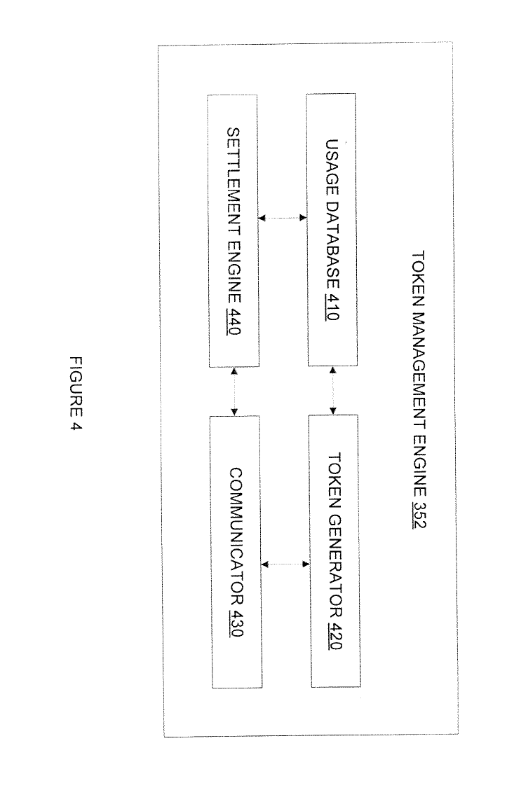

Token management engine 352 comprises different component as depicted in FIG. 4. Token management engine 352 generates token for toll-free access to Internet services and communicates to user 301 via CAPD 340. Token management engine 352 maintains the Internet usage details for user, associated IAP and ISP and perform charge settlements for toll-free usage.

Provisioning engine 355 manages user's subscription to one or more cloud services. This engine interacts with token management engine 352 to provide cloud service subscription related details for specific user. Cloud service engine 356 may offer different kind of services including Infrastructure as a Service (IaaS), Platform as a Service (PaaS), Software as a Service (SaaS) and the like. Cloud user 301 accesses this services over Internet. User 301 can be charged for these services as per the usage. Payment settlement engine 358 keeps track of cloud service usage by users 301 and maintains charges related details specific to the user. This engine may interact with cloud service engine 356 and provisioning engine 355 to keep track of availed services by respective user and perform invoicing accordingly.

FIG. 4 shows an exemplary block diagram depicting the components of token management engine 352. Token management engine 352 comprises a usage database 410, token generator 420, communicator 430 and settlement engine 440. Usage database 410 maintains the user information, associated IAP, ISP details and token information against usage of toll-free Internet access.

Token Generator 420 generates the token for toll-free Internet usage and issues it to users 301. Token generator 420 uses various access credential of user 301 from usage database 410 and generate a unique number and may cryptographically signs it with CSP's certificate. Signature of CSP 350 establishes non-repudiation and authenticity of token used in entire process. Communicator 430 works as entry and exit point for token management system 352. All requests for token generation are received by communicator 430. After token generation by token generator 420, communicator 430 sends the token to CAPD 340 for further distribution to user 301 via ISP 320. Communicator 430 further receives the token and usage attribute from ISP 320 for payment settlements.

Settlement engine 440 performs adjustments for credits and by maintaining token claimed by ISP. Settlement engine 440 retrieves access credentials of the user from usage database 410 and may compare issued and claimed usage (based on token and usage attribute) to perform financial settlements. Hence, instead of charging the user for the usage of internet services, ISP charges the CSP which has generated token for toll free connection for the user.

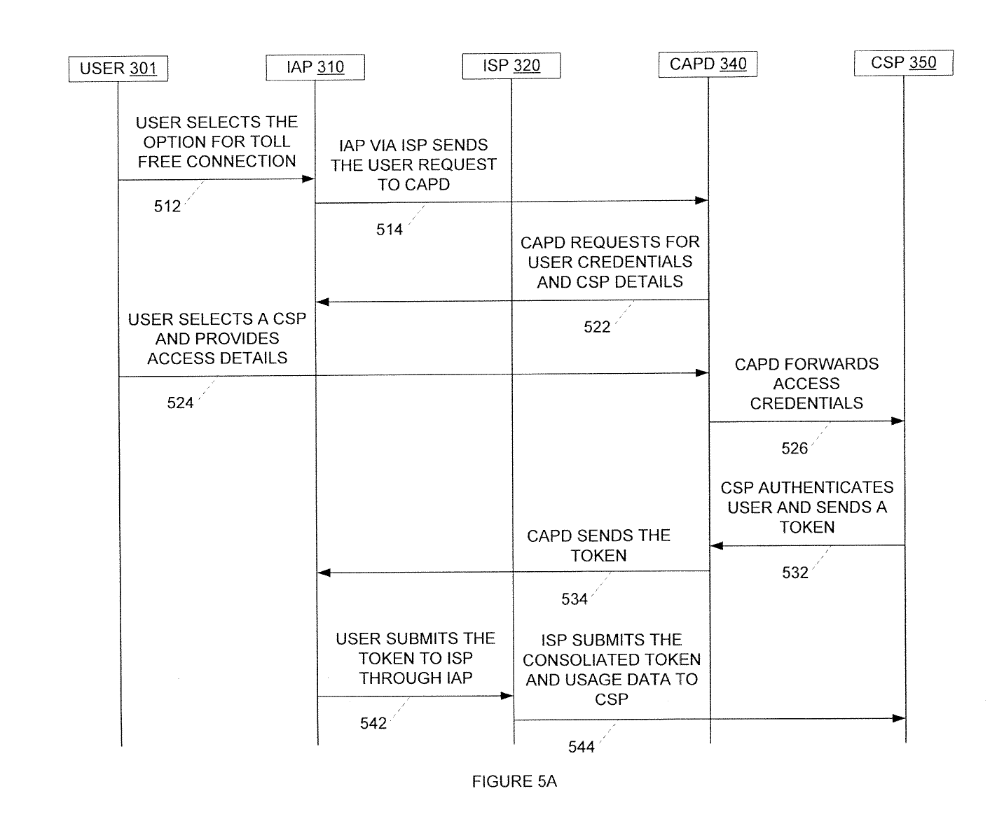

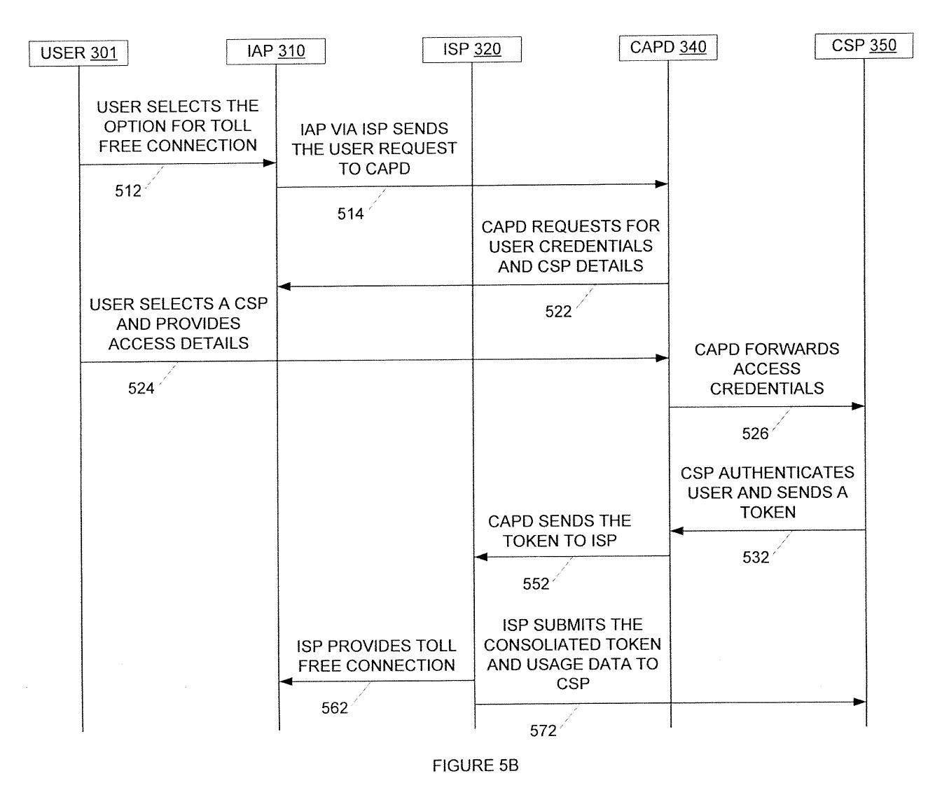

FIG. 5A illustrates an embodiment depicting the manner of providing a toll free connection to access internet services where token is received by IAP. User approaches IAP for accessing Internet services (step 512). IAP in this embodiment could be public kiosk, or a computer system in an Internet Cybercafe. User may select for an option to access internet services through a toll free connection. If the user opts for the toll free connection, IAP sends the user request to a CAPD via ISP (step 514). After CAPD receives the user request, CAPD request for inputs from the user through the IAP to select a CSP from the plurality of CSPs and provide access credentials for the selected CSP (step 522). User may select the CSP for which he/she is an existing subscriber. User provides login credentials corresponding to the selected CSP to CAPD (524). CAPD forwards the access credentials that comprises user provided parameters, IAP identifier, ISP identifier and service parameters to the CSP (step 526). CSP authenticates the user based on the received access credentials and generates a token for the user for providing toll free connection to access internet services. After the user is authenticated and same is conveyed to the CAPD, the generated token is send to the CAPD (step 532). CAPD send the token to the IAP via ISP (step 534). User can access the internet service on toll free connection using the token. User can submit the token to ISP for accessing the internet service on toll free connection (step 542). After ISP receives the token, ISP can submit the token and the usage attributes to the CSP for the payment settlement (step 544). In one embodiment, ISP can consolidate the tokens of various users and can submit all the token together along with the corresponding usage attribute to the CSP.

In another embodiment, after the user access the internet service, user can handover the token details to the IAP owner in case the IAP belongs to the third party for example, a computer system in an Internet café. Therefore, instead of user paying the internet café owner for the usage of internet services, the user provides the token to the internet café owner. The IAP owner can then, send the token to the ISP for the payment settlement. In another embodiment, IAP may maintain the token information for accounting purpose. Charges for Internet access can be claimed or adjusted based on business model between CSP and IAP. IAP sends all consolidated tokens to ISP and ISP claims to CSP for charge settlements. CSP manages payments as per business agreement between CSP, ISP & IAP after validating token and access credentials.

FIG. 5B illustrates an embodiment depicting the manner of providing a toll free connection to access internet services where token is received by ISP. In this embodiment, CAPD send the token to the ISP instead of send it to IAP (as depicted in 5A) (step 552). Based on the token, ISP can provide the IAP a toll free connection for the time specified in the token (step 562). After the user access the internet services, ISP can send the token to the CSP for payment settlement (step 572).

In another embodiment, a user may send the request and access credentials from an IAP that can be a user's own mobile device. After CSP receives the request and the user access credentials, CSP authenticates the user. As appreciated by a person skilled in the art, the user can be authenticated based on any known method in the prior art e.g. based on the registration of user IAP with CSP or based on the received access credentials. Once the user is authenticated, CSP generates a token and send the token to the IAP. User can use the token to access Internet services on a toll free connection either using the same IAP or can use the token on any other IAP. For example, if the user has received the token on his mobile, then, the user can either use the token on his mobile to access internet services or he can go to an internet café and use the token on any computer system therein to access internet services.

Exemplary Computing Environment

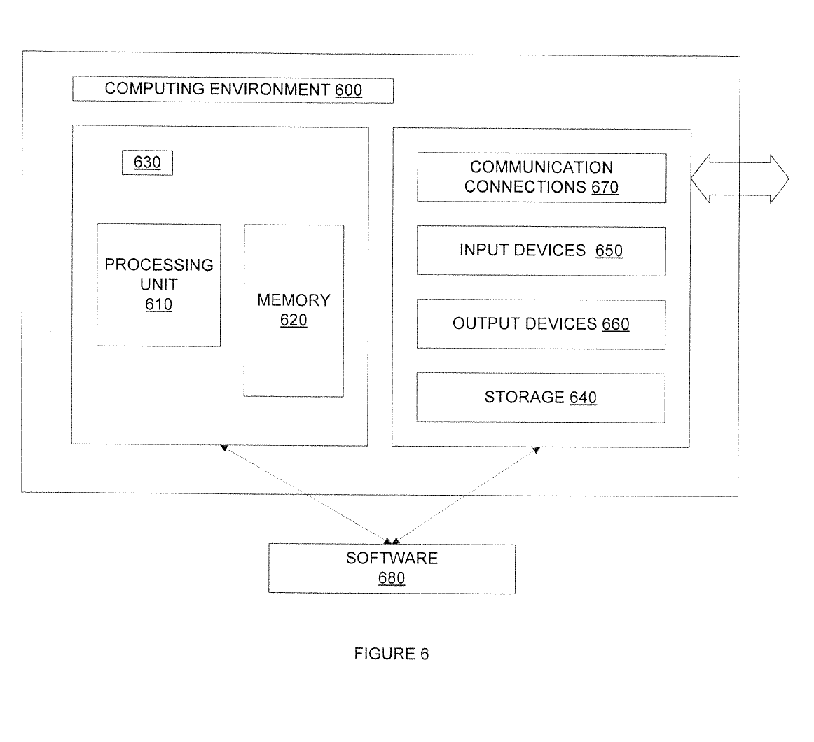

One or more of the above-described techniques may be implemented in or involve one or more computer systems. FIG. 6 illustrates a generalized example of a computing environment 600. The computing environment 600 is not intended to suggest any limitation as to scope of use or functionality of described embodiments.

With reference to FIG. 6, the computing environment 600 includes at least one processing unit 610 and memory 620. In FIG. 6, this most basic configuration 630 is included within a dashed line. The processing unit 610 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. In some embodiments, the memory 620 stores software 680 implementing described techniques.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, CD-RWs, DVDs, or any other medium which may be used to store information and which may be accessed within the computing environment 600. In some embodiments, the storage 640 stores instructions for the software 680.

The input device(s) 650 may be a touch input device such as a keyboard, mouse, pen, trackball, touch screen, or game controller, a voice input device, a scanning device, a digital camera, or another device that provides input to the computing environment 600. The output device(s) 660 may be a display, printer, speaker, or another device that provides output from the computing environment 600.

The communication connection(s) 670 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 600, computer-readable media include memory 620, storage 640, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method for providing internet services to a user through a toll free connection, the method comprising:
receiving from an Internet Access Point (IAP), by a cloud access point computing device, a request for the internet services through the toll free connection provided by a Cloud Service Provider (CSP), wherein the CSP is selected by the user from a plurality of CSPs;
receiving from the IAP, by the cloud access point computing device, one or more access credentials to access the selected CSP;
forwarding, by the cloud access point computing device, the one or more access credentials to the selected CSP;
receiving from the CSP, by the cloud access point computing device, a token, provided the user is authenticated by the CSP based on the one or more access credentials; and
sending, by the cloud access point computing device, the token to the IAP that enables the user to access the Internet services through the toll free connection.

2. The method of claim 1, wherein the token further comprises a first timestamp, wherein the first timestamp specifies a time span for which the token remains active for the user to access the Internet services through the toll free connection.

3. The method of claim 1, wherein the token is cryptographically signed with a CSP certificate to establish validation of the token.

4. The method of claim 1, further comprising enabling, by the cloud access point computing device, the IAP to receive the one or more access credentials from the user.

5. The method of claim 1, wherein the access credentials comprise:
user parameters;
an IAP identifier;
an Internet Service Provider (ISP) identifier; and
one or more service parameters.

6. A method for generating a token to be used for providing internet services to a user through a toll free connection, the method comprising:
receiving, by a cloud service provider computing device, a request to access the Internet services through the toll free connection;
receiving, by the cloud service provider computing device, one or more access credentials from an Internet Access Point (IAP);
authenticating, by the cloud service provider computing device, the user by matching the received one or more access credentials with corresponding one or more access credentials stored in a memory at the CSP;
generating, by the cloud service provider computing device, a token using the one or more access credentials; and
sending, by the cloud service provider computing device, the token to the IAP that enables the user to access the Internet services through the toll free connection.

7. The method of claim 6, further comprising:
receiving, by the cloud service provider computing device, the token and one or more usage attributes from an Internet Service Provider (ISP); and
initiating, by the cloud service provider computing device, payment process for the user usage of the Internet services based on the received token and the one or more usage attributes.

8. The method of claim 7, wherein the generated token comprises a second timestamp wherein the second timestamp specifies a time span for which the token remains active for the ISP to send the token to the CSP for initiating payment process.

9. The method of claim 7, wherein the one or more usage attributes comprise:
a usage time data; and
a usage pattern data.

10. The method of claim 6, wherein the generated token comprises a first timestamp wherein the first timestamp specifies a time span for which the token remains active for the user to access the Internet services through the toll free connection.

11. The method of claim 6, wherein the access credentials comprise:
user parameters;
an IAP identifier;
an Internet Service Provider (ISP) identifier; and
one or more service parameters.

12. The method of claim 6, wherein the token is cryptographically signed with a CSP certificate to establish validation of the token.

13. A cloud access point computing device comprising:
a processor; and
a memory coupled to the processor which is configured to be capable of executing programmed instructions comprising and stored in the memory to:
receive from an Internet Access Point (IAP) a request for the internet services through the toll free connection provided by a Cloud Service Provider (CSP), wherein the CSP is selected by the user from a plurality of CSPs;
receive from the IAP one or more access credentials to access the selected CSP;
forward the one or more access credentials to the selected CSP;
receive from the CSP a token, provided the user is authenticated by the CSP based on the one or more access credentials; and
send the token to the IAP that enables the user to access the Internet services through the toll free connection.

14. The device of claim 13, wherein the token comprises a first timestamp, wherein the first timestamp specifies a time span for which the token remains active for the user to access the Internet services through the toll free connection.

15. The device of claim 13, wherein the token is cryptographically signed with a CSP certificate to establish validation of the token.

16. The device of claim 13, wherein the processor coupled to the memory is further configured to be capable of executing the programmed instructions further comprising and stored in the memory to:
enabling the IAP to receive the one or more access credentials from the user.

17. The device of claim 13, wherein the access credentials comprises:
user parameters;
an IAP identifier;
an Internet Service Provider (ISP) identifier; and
one or more service parameters.

18. A cloud access point computing device comprising:
a processor; and
a memory coupled to the processor which is configured to be capable of executing programmed instructions comprising and stored in the memory to:
receive a request to access the Internet services through the toll free connection;
receive one or more access credentials from an Internet Access Point (IAP);
generate a token using the one or more access credentials; and
send the token to the user wherein the user uses the token to access the Internet services through the toll free connection; and
authenticate the user by matching the received one or more access credentials with corresponding one or more access credentials stored in a memory at the CSP.

19. The device of claim 18, wherein the processor coupled to the memory is further configured to be capable of executing the programmed instructions further comprising and stored in the memory to store access credentials and the corresponding generated token.

20. The device of claim 19, wherein the generated token comprises a second timestamp, wherein the second timestamp specifies a time span between which the ISP sends the token remains active for the ISP to send the token to the CSP for initiating payment process.

21. The device of claim 19, wherein the one or more usage attributes comprise:
a usage time data; and
a usage pattern data.

22. The device of claim 18, wherein the processor coupled to the memory is further configured to be capable of executing the programmed instructions further comprising and stored in the memory to:
receive the token and one or more usage attributes from an Internet Service Provider (ISP); and
initiate payment process for the user usage of the Internet services based on the received token and the one or more usage attributes.

23. The device of claim 18, wherein the generated token comprises a first timestamp, wherein the first timestamp specifies a time span for which the token remains active for the user to access the Internet services through the toll free connection.

24. The device of claim 18, wherein the access credentials comprise:
user parameters;
an IAP identifier;
an Internet Service Provider (ISP) identifier; and
one or more service parameters.

25. A non-transitory computer readable medium having stored thereon instructions for providing internet services to a user through a toll free connection which when executed by a processor, cause the processor to perform steps comprising:
receiving from an Internet Access Point (IAP) a request for the internet services through the toll free connection provided by a Cloud Service Provider (CSP), wherein the CSP is selected by the user from a plurality of CSPs;
receiving from the IAP one or more access credentials to access the selected CSP;
forwarding the one or more access credentials to the selected CSP;
receiving, from the CSP, a token, provided the user is authenticated by the CSP based on the one or more access credentials; and
sending the token to the IAP that enables the user to access the Internet services through the toll free connection.

26. A non-transitory computer readable medium having stored thereon instructions for generating a token to be used for providing internet services to a user by a Cloud Service Provider (CSP) through a toll free connection which when executed by a processor, cause the processor to perform steps comprising:
receiving a request to access the Internet services through the toll free connection;
receiving one or more access credentials from an Internet Access Point (IAP);
authenticating the user by matching the received one or more access credentials with corresponding one or more access credentials stored at the CSP;
generating a token using the one or more access credentials; and
sending the token to the user wherein the user uses the token to access the Internet services through the toll free connection.
